(19) United States
(12) Patent Application Publication
(10) Pub. No.: US 2002/0194610 A1
(43) Pub. Date: Dec. 19, 2002

(54) Surveillance digital video recorder

(76) Inventor: Kuo-Liang Lin, Hsin-Chuang (TW)

Correspondence Address: J C Patents Inc, 4 Venture Suite 250, Irvine, CA, 92618, US

(21) Appl. No.: 09/882,210

(22) Filed: Jun. 15, 2001

(51) Int. Cl. H04N 7/173

(52) U.S. Cl. 725/105; 348/143

(57) ABSTRACT

A surveillance digital video recorder system comprises a microprocessor, a principal real-time picture processor module, a picture processor module, and a data storage module. The microprocessor controls the operations of the surveillance digital video recorder system. The principal real-time picture processor module receives a plurality of picture signals that are processed into a real-time multi-frame video signal. The picture processor module receives and processes the real-time multi-frame video signal and outputs a picture signal under the control of the microprocessor. The data storage module stores motion picture computer data obtained by the picture processor module from the real-time multi-frame video signal under the control of the microprocessor.

### BACKGROUND OF THE INVENTION

1. Field of the Invention

The present invention relates to a surveillance system. More particularly, the present invention relates to a surveillance digital video recorder system.

2. Description of the Related Art

To ensure the safety of buildings and public places, surveillance video cameras conventionally are installed to monitor and record views of these sites. Each video camera is usually connected to an individual monitor that shows a view of the monitored site. Each video camera can show, for example, only one view of the monitored site. A drawback of such an installation is that the number of monitors is equal to the number of installed video cameras. Thus, if a substantial number of video cameras are installed, the surveillance is less efficient due to the numerous monitors required to monitor at the same time.

Another possible installation is that in which a single monitor is connected to several video cameras respectively installed at different locations. The display of the monitor thus alternates in a fixed time the different views of the site filmed by each video camera. Such an installation solves the problem of managing numerous monitors at the same time, but has a substantial drawback in that continuous surveillance of each monitored location of a site is not possible. A trade-off between both above-described installations thus is an installation in which a single monitor comprises a multi-frame display, each of the frames of the monitor showing the surveillance of each video camera.

The above conventional surveillance system, however, has other drawbacks. The video cameras conventionally used in a surveillance installation provide analogous picture signals. As a result, the display of the monitor in freezeframe usually flashes and is unclear. Moreover, when the surveillance is recorded onvideo tape, the recorded surveillance must be viewed according to the sequence of the video tape, and the video tape must be fast forwarded or rewinded to search for a desired frame. Such an operation is time-consuming and cumbersome.

Referring to FIG. 1A, a block diagram illustrates a conventional analog surveillance video recorder system. The picture signal from a video camera 101 first passes through a microprocessor 106 before being displayed as motion pictures on a computer monitor 108. The picture signal from the video camera also is recorded as an analog signal on a video tape 110. To avoid the disadvantages of an analog video recorder, digital video recorders can be used.

Referring to FIG. 1B, a block diagram illustrates a conventional digital video recorder system. The picture signals generated by the digital video recorder 101 are transmitted to the microprocessor 106. The microprocessor 106 processes the picture signals into video signals that then are outputted to the monitor 108 to be shown. The microprocessor 106 also stores the video signal in a hard disk 112. With such a digital video recorder system, the picture data stored in the hard disk can be rapidly accessed and the display in freeze-frame is clearer than the display in freeze-frame using an analog video recorder.

Referring to FIG. 2, a block diagram illustrates another conventional digital video recorder system used for site surveillance in which different locations of the monitored site are shown in several separate frames on the computer monitor. A plurality of digital video cameras (201˜204) respectively film the monitored site at different locations. The pictures signals from the different digital video cameras (201˜204) are respectively transmitted via an interface card 206 to a microprocessor 208. The microprocessor 208 then executes a program that transforms the different picture signals into a multi-frame video signal. The multi-frame video signal then is stored in a hard disk 210 and displayed as a motion picture on the monitor 214 via a display card 212.

From the above description, although the conventional digital video recorder system may have advantages compared to the analog video recorder system, it still generates other inconveniences such as those described hereafter. When the conventional digital video recorder system is turned on, a substantially long interval of time is necessary for the system to perform its own testing procedures. Thus, when turning on the video recorder system, the monitor 214 first shows a frame of the system and not direct on-site views of the locations filmed by the digital video cameras. Moreover, the picture signals from the video cameras (201˜204) have to be processed by the microprocessor 208 into a multi-frame video signal before being shown in multiframe fashion on the monitor 214. Actually, the microprocessor 208 sequentially processes the picture signal from each video camera (201˜204) into a video signal, which then updates the picture of the corresponding frame of the multi-frame monitor 214. As a result, if the speed of the picture display of the monitor 214 is, for example, 30 pictures per second, the speed of each frame thus is 7.5 pictures per second. Consequently, the more frames there are, the slower the picture display is.

### SUMMARY OF THE INVENTION

A major aspect of the present invention is to provide a surveillance digital video recorder system that shows direct on-site views of the monitored site immediately after it is turned on.

Another aspect of the present invention is to provide a surveillance digital video recorder system that stores the video signals and allows access to a sequence of the stored video signals by an operator selecting the time of the desired sequence.

Furthermore, another aspect of the present invention is to provide a surveillance digital video recorder system that can allow for a remote surveillance through a network.

Furthermore, another aspect of the present invention is to provide a surveillance digital video recorder system that can show the surveillance on a single monitor having at least four frames, wherein the speed of the pictures is about 30 pictures per second for each frame. The conventional picture delays due to the slower speed of the pictures thus can be prevented. With the surveillance digital video recorder system of the present invention, the speed of the pictures can be increased to above 120 pictures per second.

To attain the foregoing and other objectives, a surveillance digital video recorder system, according to a preferred embodiment of the present invention, comprises a microprocessor, a principal real-time picture processor module, a picture processor module, and a data storage module. The microprocessor controls the operations of the surveillance digital video recorder system. The principal real-time picture processor module receives a plurality of picture signals that are processed into a real-time multi-frame video signal. The picture processor module receives and processes the real-time multi-frame video signal and outputs a picture signal under the control of the microprocessor. The data storage module stores motion picture computer data obtained by the picture processor module from the real-time multi-frame video signal under the control of the microprocessor.

In another embodiment of the present invention, the surveillance digital video recorder system further comprises a plurality of real-time picture processor modules from which the principal real-time picture processor module receives the picture signals.

Alternatively, the surveillance digital video recorder system also can comprise a network interface component that allows for a remote surveillance.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1A through FIG. 2 are block diagrams that respectively illustrate different conventional surveillance video recorder systems.

FIG. 3 is a block diagram schematically illustrating a surveillance digital video recorder system according to a preferred embodiment of the present invention;

FIG. 4 is a block diagram schematically illustrating a surveillance digital video recorder system according to another preferred embodiment of the present invention; and

FIG. 5 is a block diagram schematically illustrating a surveillance digital video recorder system with sixteen viewing frames according to another embodiment of the present invention.

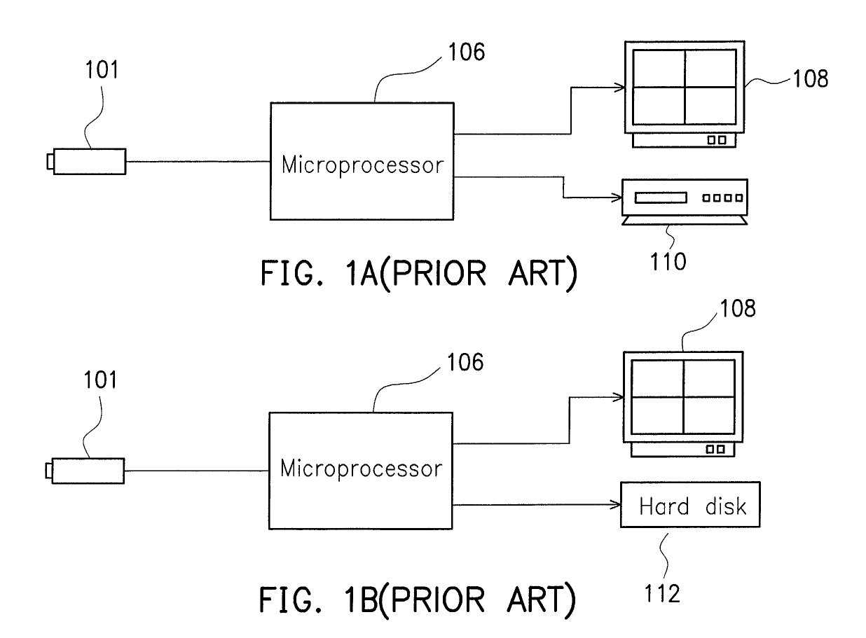

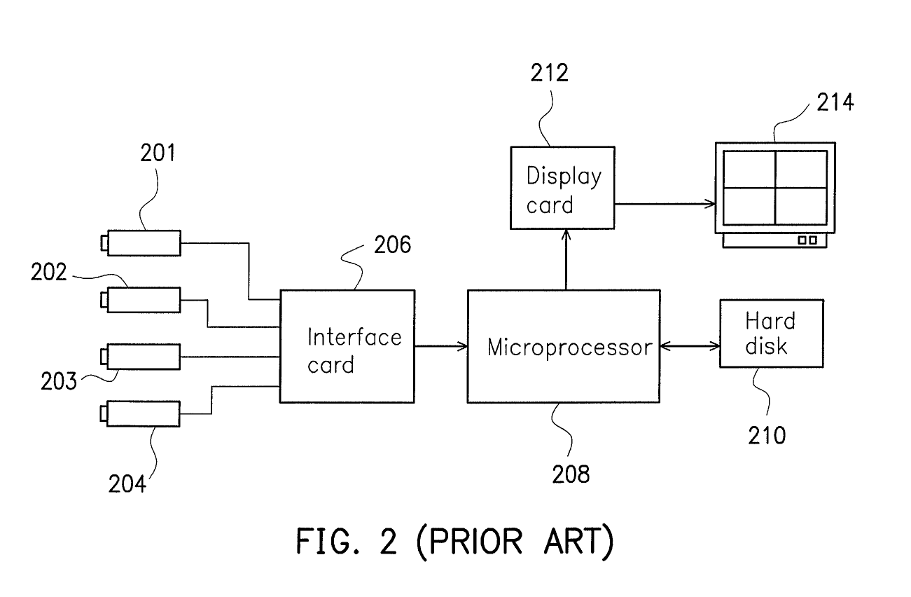

### DESCRIPTION OF THE PREFERRED EMBODIMENTS

The following detailed description of the embodiments and examples of the present invention with reference to the accompanying drawings is only illustrative and not limiting.

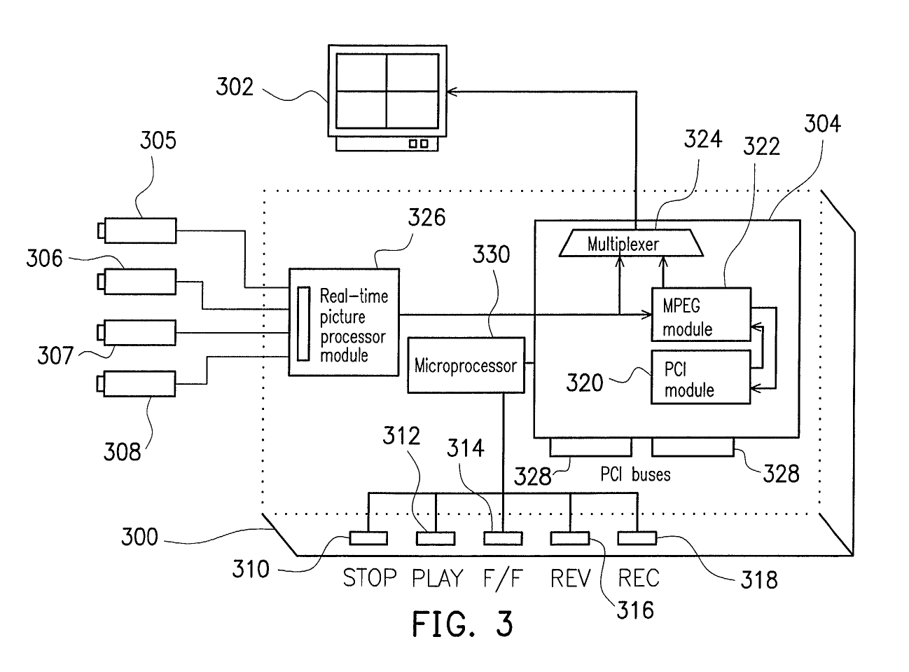

Referring to FIG. 3, a block diagram schematically illustrates a surveillance digital video recorder system according to a preferred embodiment of the present invention. A surveillance digital video recorder system 300 is connected to a monitor 302 and, for example, four video cameras (305˜308). The surveillance digital video recorder system 300 also is provided with a plurality of control keys (310˜318) thereon. These control keys comprise a Stop key 310, a Play key 312, a Fast Forward key 314, a Fast Reverse key 316, and a Record key 318.

In the present embodiment, the surveillance digital video recorder system 300 comprises a microprocessor 330, a real-time picture processor module 326, and a picture processor module 304. The microprocessor 330, by outputting a control signal, controls the operations of the surveillance digital video recorder system 300 commanded by an operator via the control keys (310˜318). When one of the control keys (310˜318) is pressed, a signal is delivered to the microprocessor 330, which outputs a corresponding control signal.

The real-time picture processor module 326 receives a plurality of picture signals from each video camera (305˜308) and processes these picture signals into video signals that can be shown as real-time motion pictures on the monitor in multi-frame fashion. The video signals from the real-time picture processor module 326 are delivered to the picture processor module 304 to be processed in a manner that depends on the control signal output by the microprocessor 330.

In the present preferred embodiment, the picture processor module 304 comprises a motion picture computer data module such as a MPEG (Motion Picture Expert Group) module 322, a data storage interface 320, and a multiplexer 324. The data storage interface 320 can be, for example, a PCI (Peripheral Component Interface) module. Other types of storage interfaces, however, can be used. The motion picture computer data module principally generates motion picture computer data that can be stored and read from video signals.

The video signals output from the real-time picture processor module 326 are separately delivered to the multiplexer 324 and the MPEG module 322 within the picture processor module 304. When the surveillance digital video recorder system 300 is turned on, the video signals, output from the real-time picture processor module 326 to the picture processor module 304, thus can be immediately output to the monitor 302 via the multiplexer 324 for a direct on-site view of the monitored site. The disadvantage of the conventional system, in which the system has to complete its automatic testing procedures before the site is effectively shown on the monitor, thus can be eliminated in the present invention.

When the Record key 318 is pushed, the microprocessor 330 outputs a corresponding control signal to command the delivery of the video signal to the MPEG module 322 to be transformed into a MPEG format file. The MPEG file via the storage interface module 320 and the buses 328 (for example a PCI bus) then is stored in a data storage module (not shown). While recording, the video signals also are continuously transmitted to the monitor 302. In other words, the video signals output from the real-time picture processor module 326 are identically output from the picture processor module 304. The data storage module can be, for example, a hard disk.

When the Play key 312 is pushed, the microprocessor 330 outputs a corresponding control signal to command the access to the MPEG file stored in the data storage module. The MPEG file then is output from the data storage module to the MPEG module 322 via the storage interface module 320 and the buses 328. The MPEG module 322 processes the MPEG file into picture signals that are output to the monitor 302 via the multiplexer 324. Similarly, when the Fast Forward key 314 or the Fast Reverse key 316 are pushed, the video signals output from the picture processor module 304 are the picture signals processed by the MPEG module 322 from the data storage module.

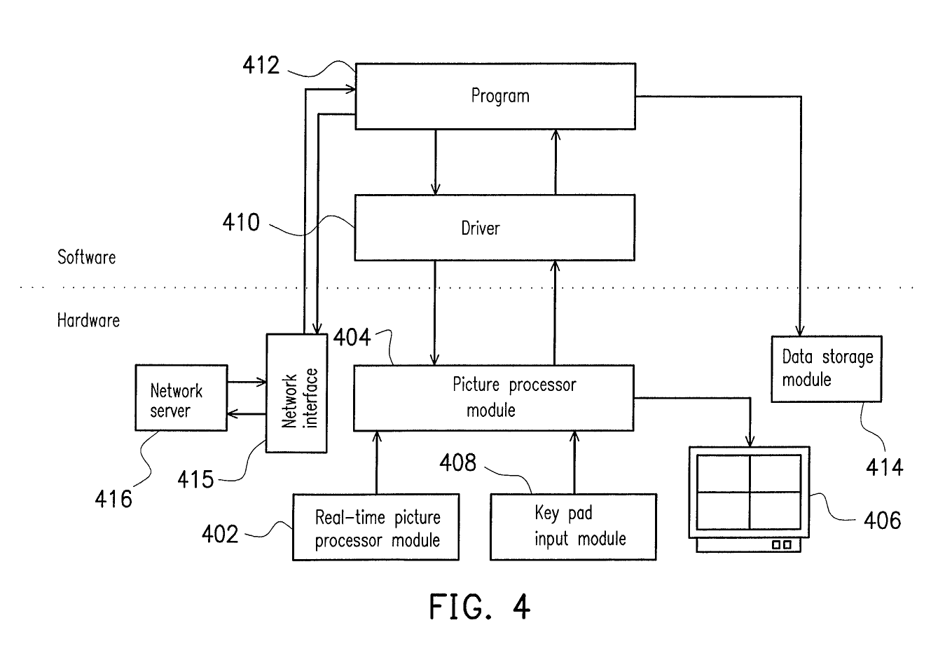

Referring to FIG. 4, a block diagram schematically illustrates a surveillance digital video recorder system according to another embodiment of the present invention. After the surveillance digital video recorder system is turned on, the microprocessor (not shown) sets the picture processor module 404 such that the video signals from the real-time picture processor module 402 can be delivered to the monitor 406 for a direct on-site view. An operator, using a key pad input module 408, commands the surveillance digital video recorder system via the microprocessor that outputs a control signal to control the operation of the picture processor module 404, as previously described and illustrated in FIG. 3. The function of the key pad input module 408 thus comprises that of the control keys (310˜318) of the previous embodiment.

If, for example, a record signal is input from the key pad input module 408, the microprocessor sets the real-time picture processor module 402 to output the video signal to the picture processor module 404. While the monitor 406 keeps showing direct on-site views, a driver 410 of the picture processor module 404 processes the video signals into an MPEG file which, via the control of a program 412, is stored in a data storage module 414 that can be, for example, a hard disk.

If a play signal is input from the key pad input module 408, the program 412 reads the desired MPEG file in the data storage module 414. Under the control of the driver 410, the picture processor module 404 processes the MPEG file into picture signals that are output to the monitor 406. In the present embodiment, when the MPEG file is read, the microprocessor outputs, for example, a high voltage to set a multiplexer within the picture processor module 404, identical to that illustrated in FIG. 3, such that the picture processor module 404 only outputs picture signals from the MPEG file. While viewing previously recorded picture signals, the operator can fast reverse or fast forward to find the desired sequence via the key pad input module 408; alternately, the operator can view the recorded picture signals by directly selecting the desired time of a sequence. As a result, the search time of a stored MPEG file can be reduced.

The digital video recorder system of the present invention can be used as a surveillance system installed into buildings and public sites. Via an internet access module, the surveillance digital video recorder system of the present invention also can perform remote surveillance.

Referring to FIG. 4, a network server 416, for example, can output a request signal for direct on-site surveillance. This request signal, via a network interface component 415, is transmitted to the program 412. When receiving the request signal, the program 412 reads the corresponding MPEG file in the data storage module 414 and transmits the MPEG file to the network server 416. Remote surveillance from, for example, the network server 416 then can be performed. It should be apparent that the above-described example in which remote surveillance is performed from a network server is only an example of various possible network structures in which remote surveillance can be achieved by other computers connected to a network server.

In the previous embodiments, an exemplary monitor is described comprising four visualization frames. Other numbers of visualization frames are possible depending on the choice of the design.

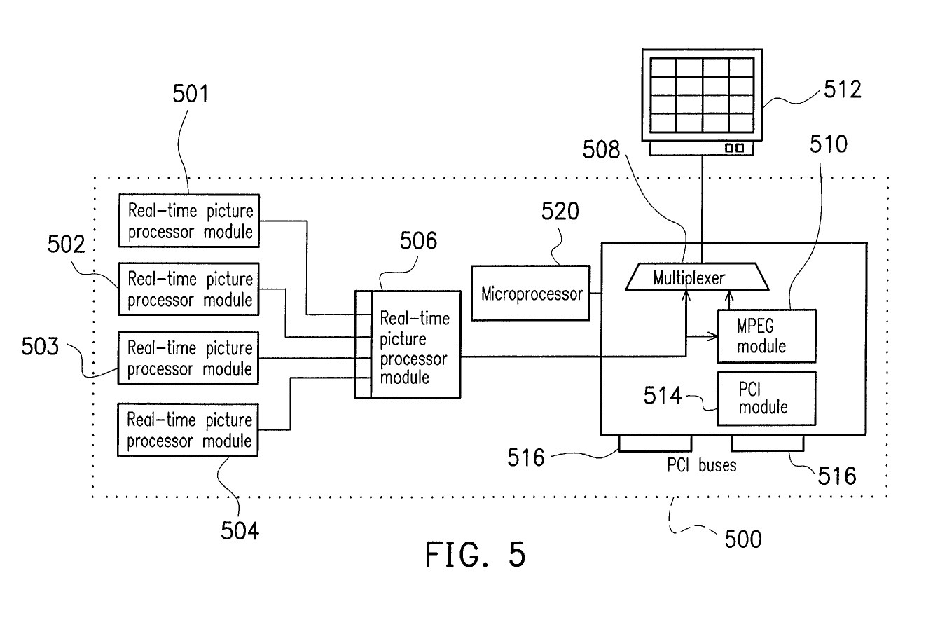

Referring to FIG. 5, a block diagram schematically illustrates a surveillance digital video recorder system according to another embodiment of the present invention. Within the surveillance digital video recorder system of this embodiment, the monitor 512 comprises sixteen visualization frames, for example. The structure of the surveillance digital video recorder system of the present embodiment is similar to that of FIG. 3 except that the video cameras (305˜308) are substituted with a plurality of real-time picture processor modules (501˜504). Each of the real-time picture processor modules (501˜504) processes a picture signal from a digital video camera into, for example, a four-frame video signal. The video signal output by the principal real-time picture processor module 506 thus is a sixteen-frame video signal. Other elements of FIG. 5, such as the microprocessor 520, PCI buses 516, PCI modules 514, the MPEG module 510, and the multiplexer 508, substantially perform the same functions as the like elements of FIG. 3. The increase of the number of viewing frames on the monitor is simply obtained by the increase of the number of real-time picture processor modules (501˜504).

In conclusion, with the present invention, when the surveillance digital video recorder system is turned on, direct on-site views are immediately shown. Moreover, when viewing a recorded picture data, the desired sequences can be rapidly accessed and shown by simply selecting the time of the sequences. Furthermore, with the connection of the surveillance digital video recorder system to a computer network, the present invention allows for remote site surveillance.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A surveillance digital video recorder system used to monitor a site, comprising:
a monitor that shows the monitored site;
a microprocessor that controls the operations of the surveillance digital video recorder system by outputting a control signal;
a principal real-time processor module that receives and processes a plurality of picture signals into a real-time multi-frame video signal;
a picture processor module that receives and processes the real-time multi-frame video signal and outputs a picture signal to the monitor, wherein the processing of the real-time multi-frame video signal and the picture signal output by the picture processor module depends on the control signal output by the microprocessor; and
a data storage module that stores pictures of the monitored site filmed by the surveillance digital video recorder system.

2. The system of claim 1, wherein the picture processor module comprises:
a motion picture computer data module that transforms the real-time multi-frame video signal into a motion picture computer data that can be stored in the data storage module;
a data storage interface that serves as a data transmission interface between the picture processor module and the data storage module; and
a multiplexer that designates the picture signal output by the picture processor modules as either the real-time multi-frame video signal or a picture signal obtained from the reading of the motion picture computer data stored in the data storage module, depending on the control signal output by the microprocessor.

3. The system of claim 1, wherein the data storage module is a hard disk.

4. The system of claim 1, further comprising a network interface component through which the motion picture computer data can be put onto a network.

5. The system of claim 2, wherein operations of the surveillance digital video recorder system controlled by the microprocessor comprise: a record operation, a fast forward operation, a fast reverse operation, a normal play operation, and a stop operation.

6. The system of claim 5, wherein during a record operation, the picture signal output by the picture processor module via the multiplexer is the real-time multi-frame video signal, wherein the real-time multi-frame video signal also is transformed into motion picture computer datum that are stored in the data storage module.

7. The system of claim 5, wherein during a normal play operation, the picture signal output by the picture processor module via the multiplexer is from the motion picture computer datum stored in the data storage module.

8. The system of claim 5, further comprising a command board, the command board comprising:
a key that commands the record operation;
a key that commands the fast forward operation;
a key that commands the fast reverse operation;
a key that commands the normal play operation; and
a key that stops the fast forward operation, the fast reverse operation, the normal play operation or the record operation.

9. The system of claim 1, further comprising a plurality of real-time picture processor modules from which the picture signals are output to the principal real-time picture processor module.
